(19) United States
(12) Patent Application Publication
(10) Pub. No.: US 2007/0005461 A1
(43) Pub. Date: Jan. 4, 2007

(54) Business tax organizing method and system

(76) Inventor: Kenneth R. Lenz, Pleasant Garden, NC (US)

Correspondence Address: LITMAN LAW OFFICES, LTD, PO BOX 15035, CRYSTAL CITY STATION, ARLINGTON, VA, 22215, US

(21) Appl. No.: 11/149,310

(22) Filed: Jun. 10, 2005

(51) Int. Cl. G06Q 40/00

(52) U.S. Cl. 705/31

(57) ABSTRACT

The business tax organizing method and system provides a web page for interactive online communication with a user/prospective client. A business entity type of the user is identified. Then the user is interviewed about business tax issues related to the identified business entity type. User responses and related calculations are stored in a backend database. The responses and calculations are organized into a tax preparation input file which, when directed by a client who has finished responses and has signed on to a tax preparation service, is transmitted to a tax preparer for preparing a business tax return.

### BACKGROUND OF THE INVENTION

1. Field of the Invention

The present invention relates to computerized systems and methods relating to income tax preparation, and particularly to a business tax organizing method and system that includes an automated process of interviewing a client or prospective client for the purpose of collecting and organizing information required for business tax preparation.

2. Description of the Related Art

There exists a long felt need for the capability of accepting business tax clients on a 24 hour per day/7 day per week basis, and preferably an automated system that eliminates the need for additional support information for the data entry phase of the business tax preparation process. In addition, there exists a need to free the tax preparer from the mundane activities of data mining and data entry, while at the same time allowing the tax client who is a business entity, e.g., a partnership, a LLC, a corporation, a sole proprietor, and the like, to enter the required data for tax preparers at any time convenient for the business entity. There also exists a need among business entities to save money while performing required data entry in support of business tax preparation. This saved money can be spent elsewhere in the business, or expended for expert advice of the tax preparer, rather than for data entry. Further, there is a need for a convenient yet secure environment in which the business entity can enter the tax data without paying a live tax preparer during business hours. Moreover, automated compliance checking of tax information input by the user would be desirable.

Thus, a business tax organizing method and system solving the aforementioned problems is desired.

### SUMMARY OF THE INVENTION

The business tax organizing method and system provides a web page for an interactive online communication with a user/prospective client. The system confirms that the user is a business entity, and then the user is interviewed about business tax issues related to the type of business entity. User responses and related calculations are stored in a backend database. The responses and calculations are organized into a tax preparation input file, which, when directed by a client who has finished responses and has signed onto a tax preparation service, is transmitted to a tax preparer for preparing a business tax return. These and other features of the present invention will become readily apparent upon further review of the following specification and drawings.

### BRIEF DESCRIPTION OF THE DRAWINGS

FIG. 1 is a block diagram of a business tax organizing system showing Internet connectivity according to the present invention.

FIG. 2 is a block diagram illustrating the inputs and outputs of the business tax organizing system of the present invention.

FIG. 3 shows the Master Flow Chart of the business tax organizing method of the present invention.

FIG. 4 illustrates a flowchart of the identity module of the business tax organizing system of the present invention.

FIG. 5 illustrates a flowchart of the client acceptance module of the business tax organizing system of the present invention.

FIG. 6 illustrates a flowchart of the Marketing Contacts module of the business tax organizing system of the present invention.

FIG. 7 illustrates a flowchart of the Client Input module of the business tax organizing system of the present invention.

FIG. 8 illustrates a flowchart of the Basic Data and Questionnaire module of the business tax organizing system of the present invention.

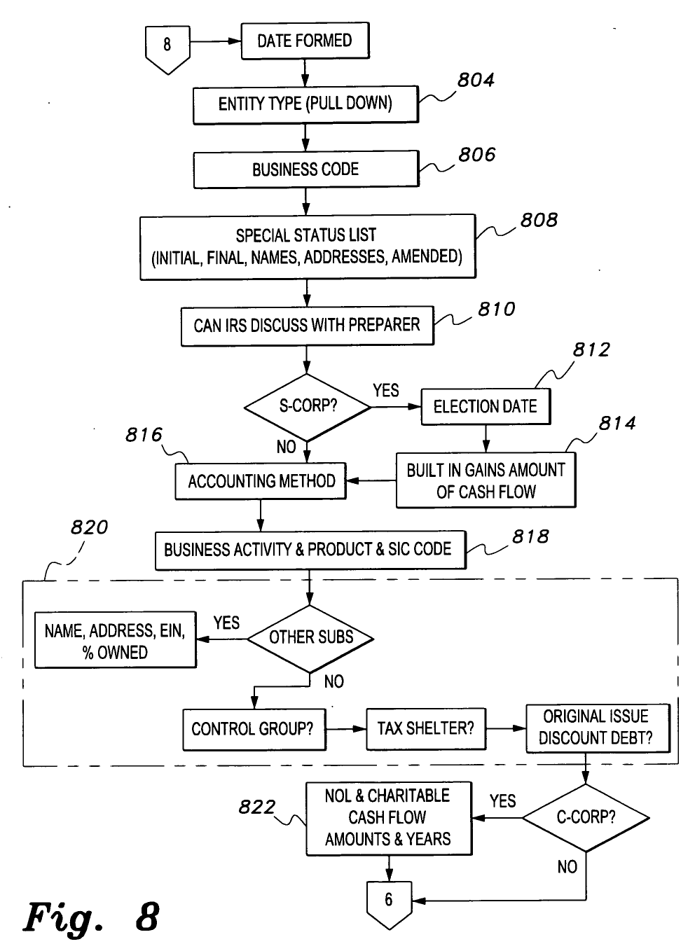

FIG. 9 illustrates a flowchart of the Revenue and Capital Gains module of the business tax organizing system of the present invention.

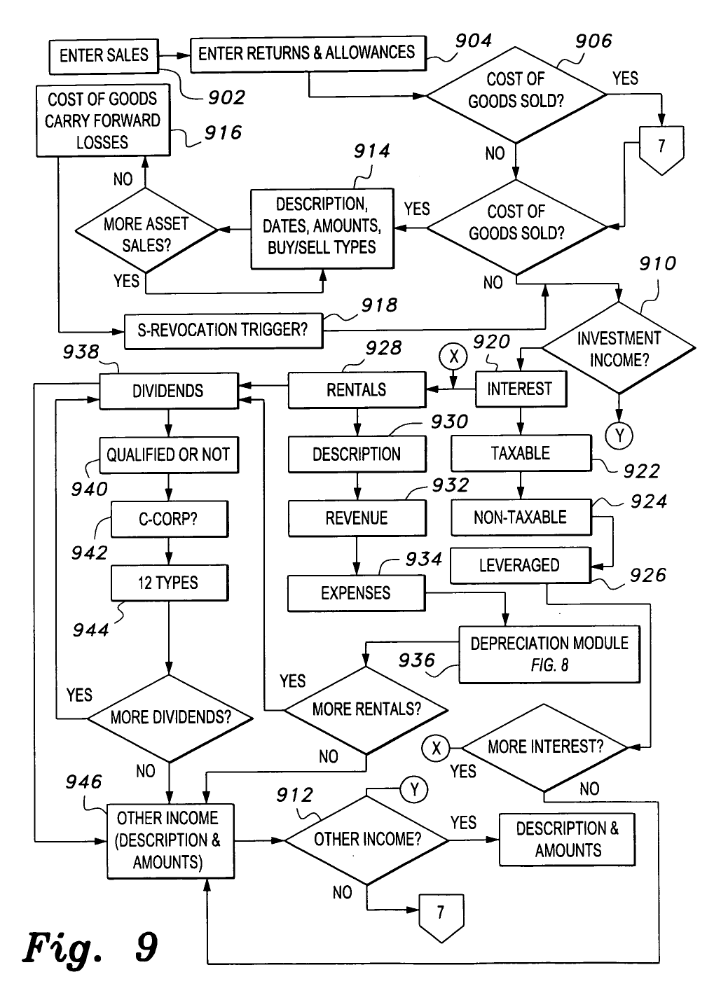

FIG. 10 illustrates a flowchart of the Expenses and Cost of Goods Sold module of the business tax organizing system of the present invention.

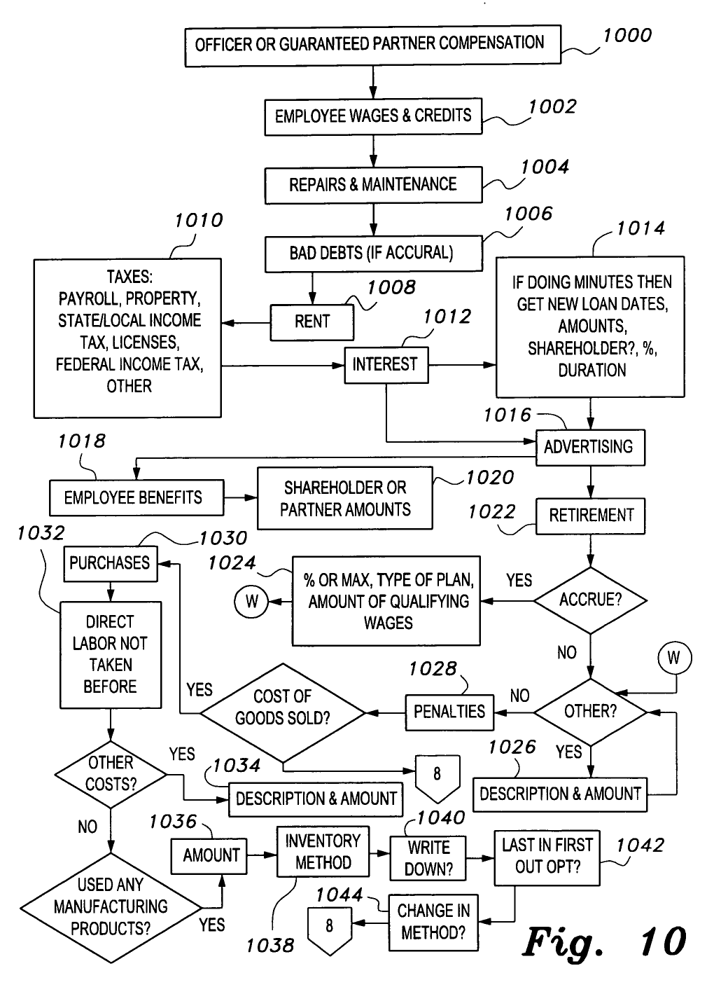

FIG. 11 illustrates a flowchart of the Depreciation/Amortization/Depletion module of the business tax organizing system of the present invention.

FIG. 12 illustrates a flowchart of the Credits/Payments/Other Taxes module of the business tax organizing system of the present invention.

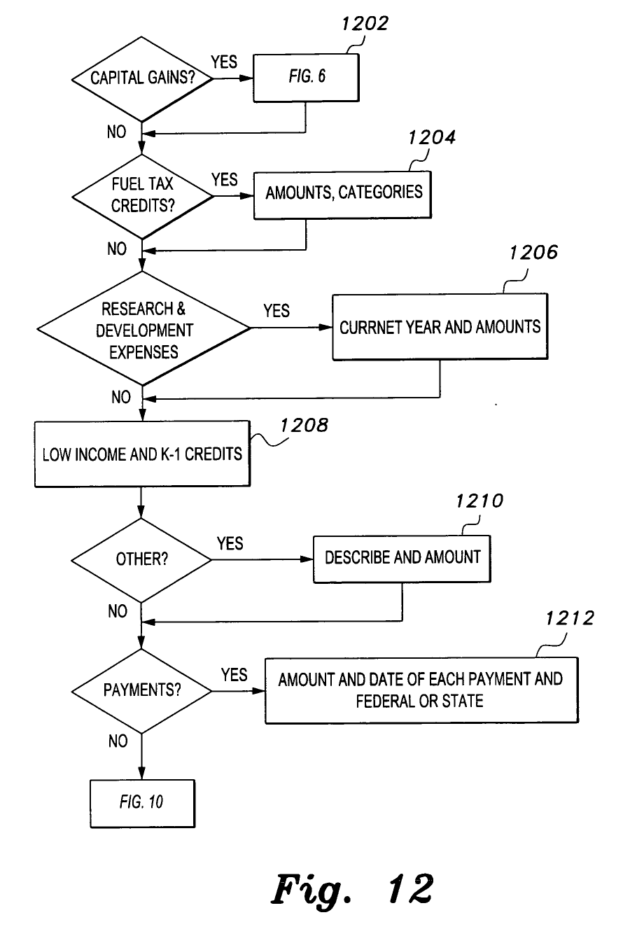

FIG. 13 illustrates a flowchart of the Balance Sheet module of the business tax organizing system of the present invention.

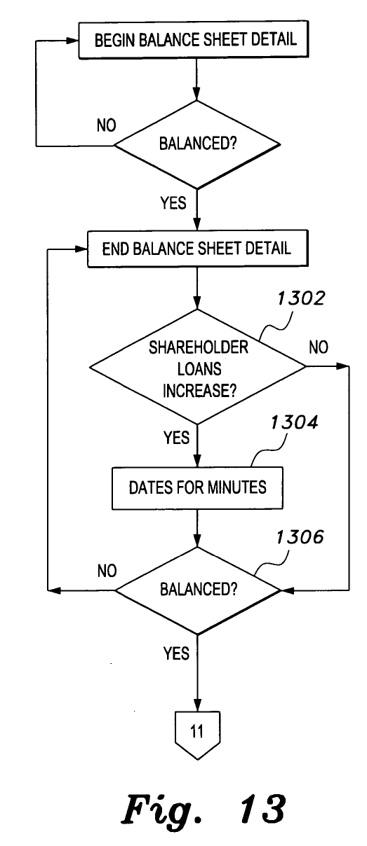

FIG. 14 illustrates a more detailed flowchart of the Balance Sheet module of the business tax organizing system of the present invention.

FIG. 15 illustrates a flowchart of the Basis module of the business tax organizing system of the present invention.

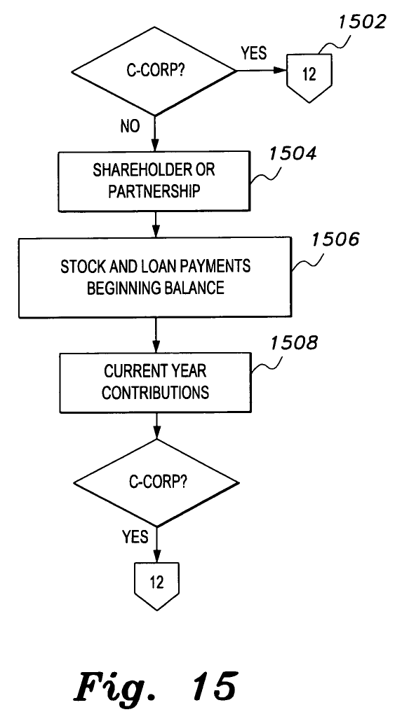

FIG. 16 illustrates a flowchart of the States module of the business tax organizing system of the present invention.

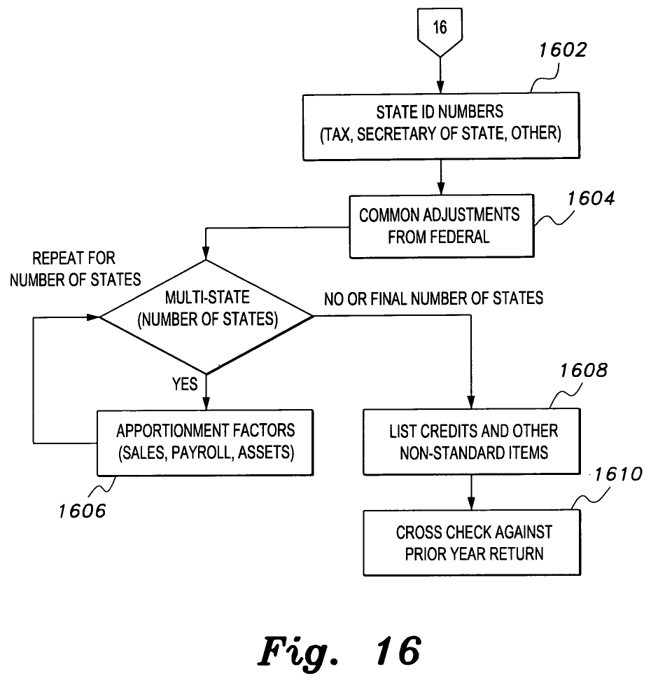

FIG. 17 illustrates a flowchart of the Minutes module of the business tax organizing system of the present invention.

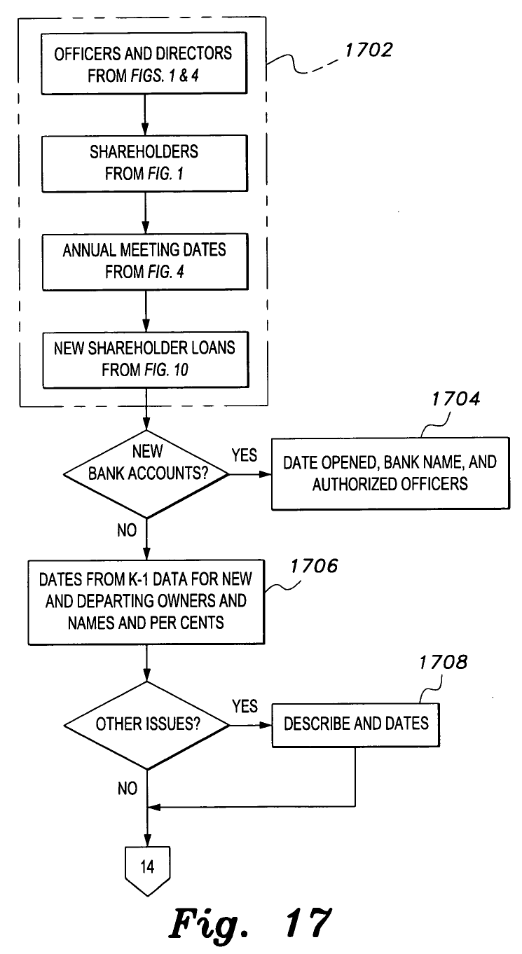

FIG. 18 illustrates a flowchart of the Certification and Release module of the business tax organizing system of the present invention.

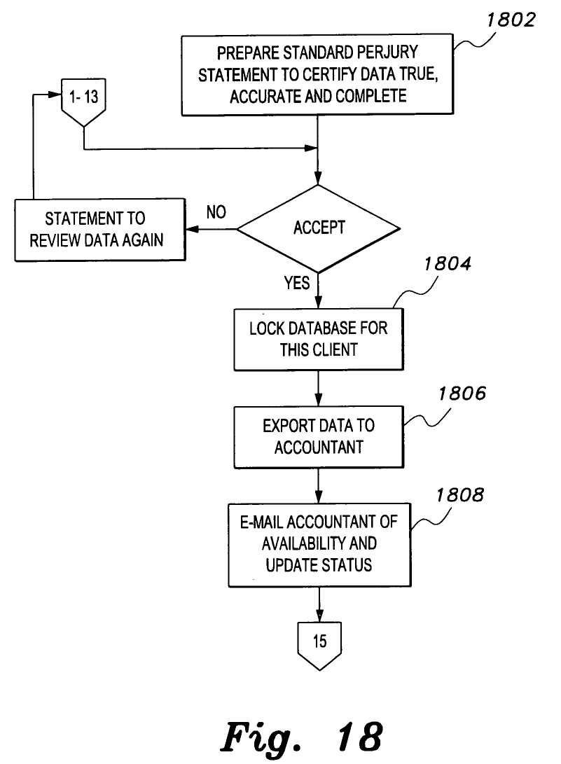

FIG. 19 illustrates a flowchart of the Client Follow-Up and Planning module of the business tax organizing system of the present invention.

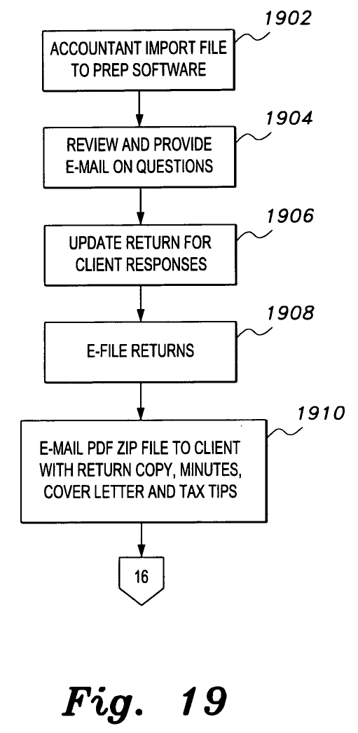

FIG. 20 illustrates a flowchart of the Wrap-Up module of the business tax organizing system of the present invention.

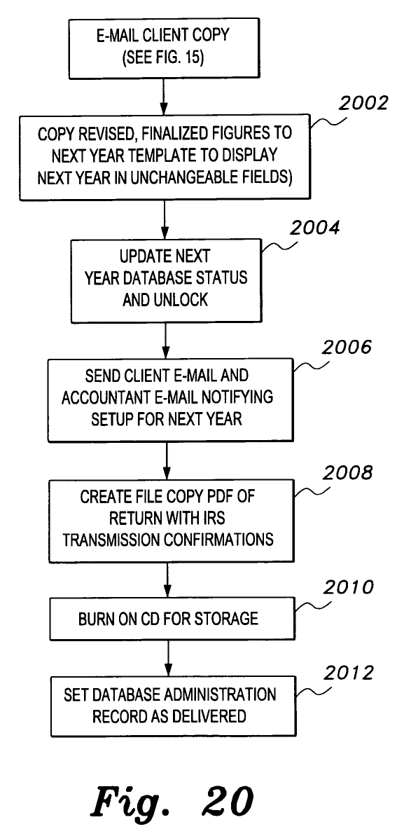

Similar reference characters denote corresponding features consistently throughout the attached drawings.

### DETAILED DESCRIPTION OF THE PREFERRED EMBODIMENT

The present invention is a business tax organizer system 100 and method for providing tax related information required of a business entity by a tax preparer. The method is performed on a machine, such as a computer, executing a program of instructions tangibly embodied in a program storage device readable by the machine, and comprises providing a web page for interactive communication with at least one user 105; identifying a business entity type of the user; interviewing the user about business tax issues related to the business entity type identified; storing responses of the user in a backend database 112; storing calculations related to the responses of the user 105 in the backend database 112; organizing the responses and the calculations into a tax preparation input file; and, transmitting the tax preparation input file to a tax preparer, e.g., an accountant 115.

According to the present invention, mathematical arrays of dynamic tables are segmented and encrypted for each user, thus assuring a secure data storage area for each user's business tax data. The dynamic tables of the present invention increase the efficiency of each user's business tax data by dynamically allocating storage space according to user requirements, particularly for database items that cannot be determined in advance, such as depreciable items, number of multiple states, other expenses, and the like.

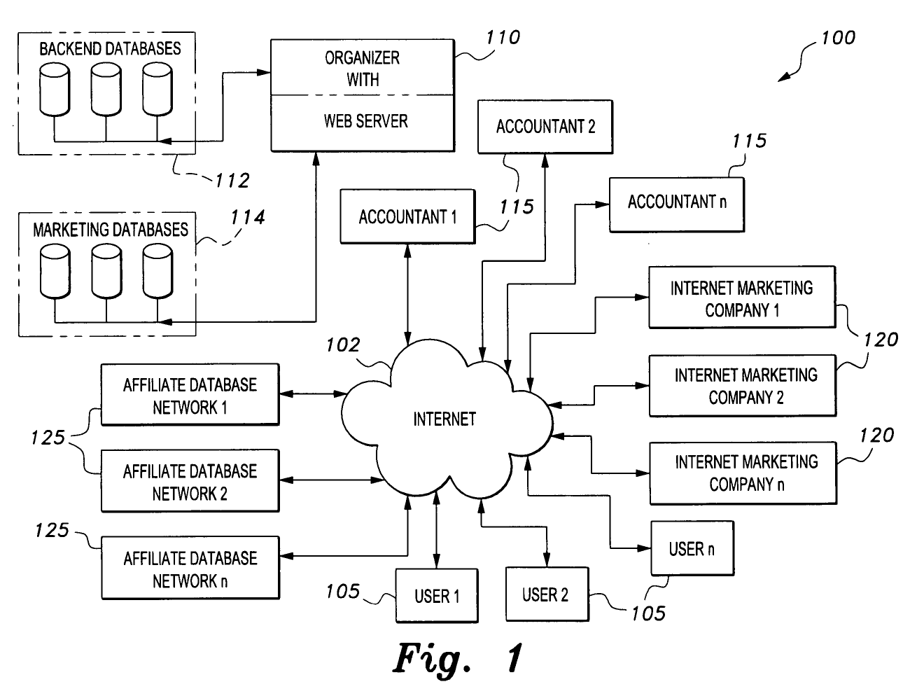

According to the present invention, the need for a universal, i.e., without geographical restrictions, yet secure environment in which the business entity can enter the tax related information without paying a live preparer during business hours is provided by an Internet connection. As shown in FIG. 1, the Internet connection of the Web server 110 with organizer software executing thereon to the Internet 102 provides a means for the organizer to simultaneously communicate with multiple client sources 105, independent marketing databases 114, and, multiple accounting firms 115 utilizing multiple tax packages, via multiple outputs.

As provided by the present invention, users can connect to the business tax organizing system from any geographical location, and from any Web-enabled device, with the effect of eliminating geographical restrictions on tax practice building and tax practice management while maintaining client-accountant communication. In addition, the present invention can be implemented in a variety of computing environments, including, but not limited to, a distributed processing environment, or a central processing environment.

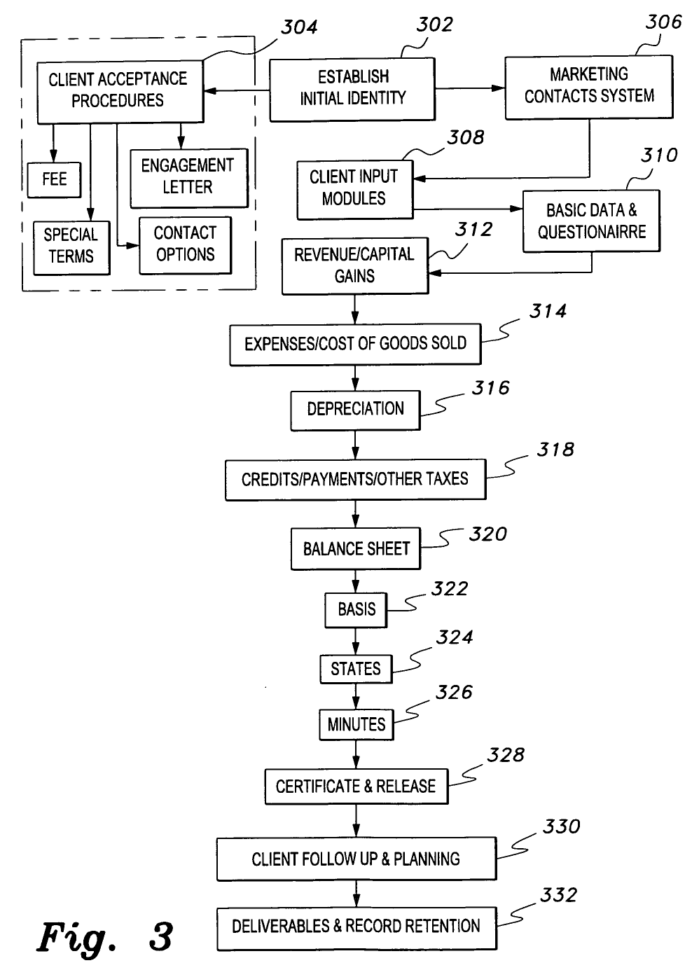

Referring to FIG. 3, according to the present invention, the business tax organizing method and system comprises an identity module 302 for establishing client identity; a client acceptance module 304 for initial processing of the client including fee processing, encryption generation, and the like; and, a marketing contacts module 306 for inclusion of the client in a marketing database 114 (of FIG. 1).

In addition, client input modules 308 are provided to prompt the client for a type of tax information input depending on the type of client business entity filing, i.e., based on whether the business entity filing is for, e.g., a C corporation, an S corporation, a partnership, a sole proprietorship, and the like.

According to the present invention, a basic data and questionnaire module 310 is provided to further establish entity type, business code, accounting method, and the like. In addition, the present invention provides a revenue and capital gains module 312; an expenses and cost of goods sold module 314; a depreciation/amortization/depletion module 316; a credits/payments/other taxes module 318; a balance sheet module 320; a basis module 322; a State tax module 324; a business entity minutes module 326; a certification and release module 328; a client follow-up and planning module 330; and, a wrap-up module 332.

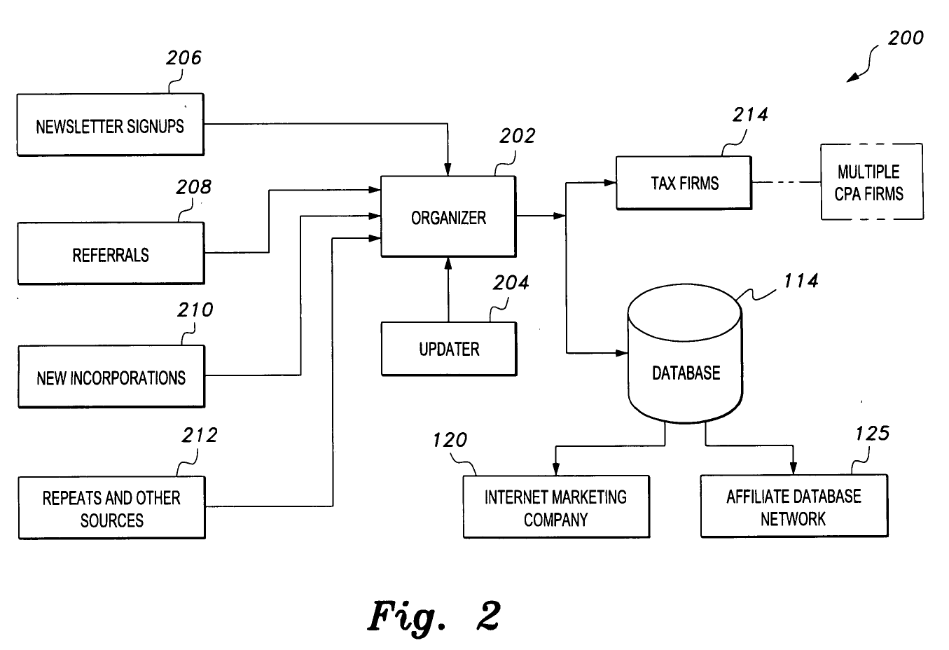

The method and system of the present invention includes updates generated by an updater 204, shown in FIG. 2, to assure that the software modules track complexities of over 98.5% of the tax return preparation requirements for all small business S corporations, C Corporations, and partnership business tax items. This same level of tracking, i.e., to within one standard deviation, is maintained for multistate return adjustments and corporate law minimum requirements for preserving incidents and formalities of corporate or limited liability company annual reporting requirements.

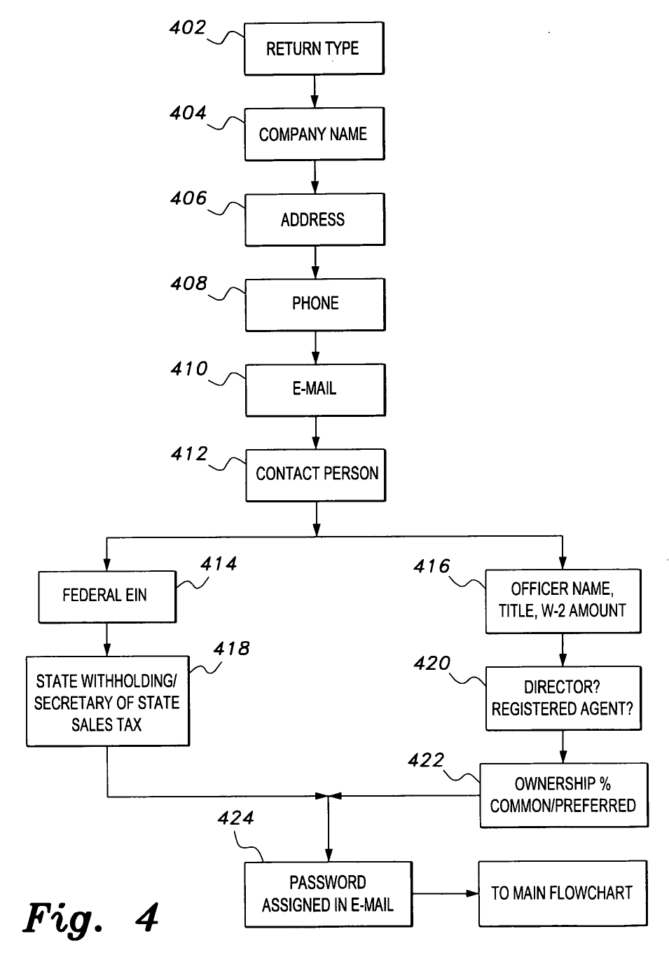

Referring to FIG. 4, the present invention provides for establishing the identity of the business entity as follows: the interviewer gathers information from a prospect/client on return type 402, company name 404, company address 406, telephone contact number 408, e-mail address 410, and contact person 412.

Additional information on federal EIN 414, state withholding, Secretary of State and sales tax 418 is gathered. The organizer also gathers information on corporate officer name, title and W-2 amount 416. A determination is made, based on user responses to organizer interview questions, as to whether the user is a director, registered agent 420, and whether the user owns common or preferred stock and what percentage ownership 422. After this preliminary information is gathered and stored by the interviewer, a password is assigned in e-mail 424. It should be noted that the information gathered at this stage of the interview is migrated to a marketing contacts system, which comprises, in part, a marketing database 114.

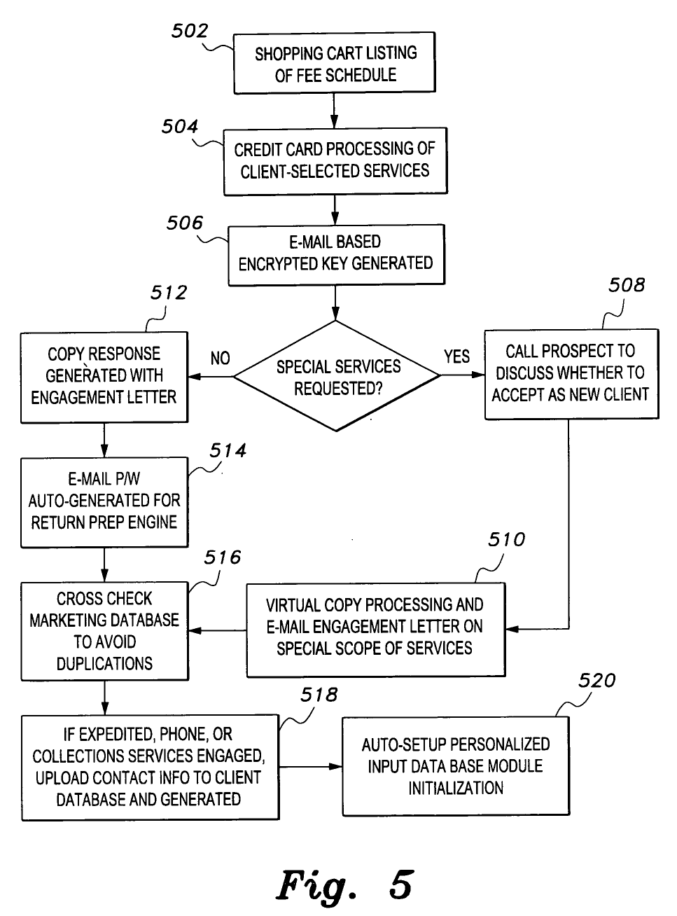

Client information is also migrated to the input of a client acceptance module in which client acceptance procedures are provided by the present invention. During the client acceptance phase, it is within the scope of the present invention to provide a fee determination, an engagement letter, contact options, and special terms. For example, as shown in FIG. 5, a shopping cart listing of fee schedule 502 may be provided. Credit card processing of client-selected services 504 may be provided. An email based encryption key is generated 506.

If the client requests special services a notice is sent to the tax preparer to call the prospective client for a discussion of whether to continue the engagement 508. If the engagement is to continue under the special services request a special engagement letter is generated 510 and the normal flow of processing is resumed. For non-special services, an engagement letter and processing letter are generated 512, and virtual copied. An auto-generated password is emailed to the client 514. For either non-special services or special services, the marketing database 114 is crosschecked to avoid duplications 516. If expedited, phone or collections services are engaged and contact information is generated and uploaded to the client database 518. Next, a personalized input database module for user responses and related calculations is initialized 520.

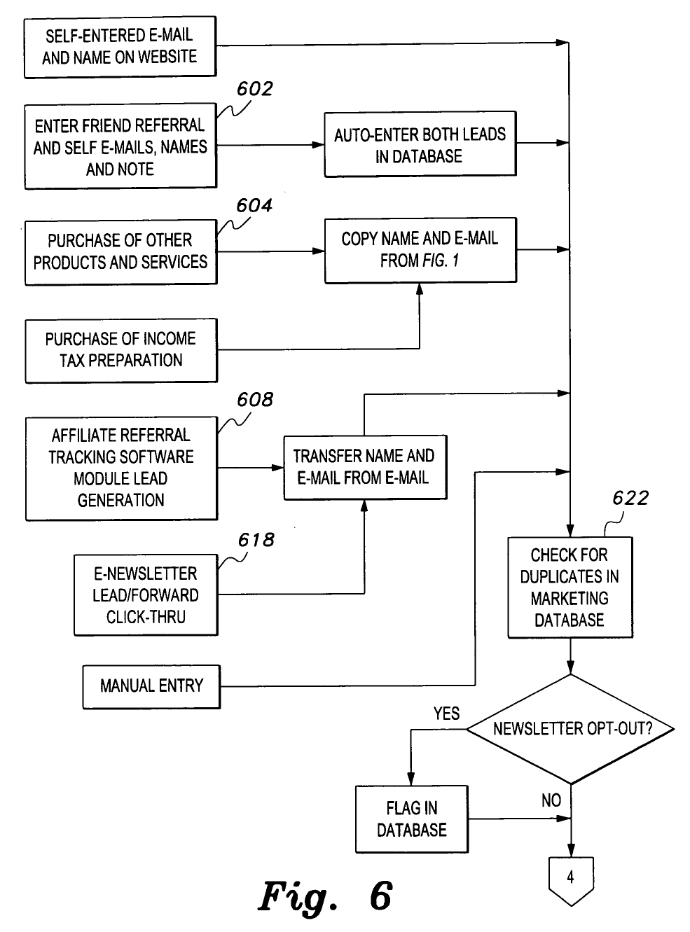

Referring to FIG. 6, it should be noted that the goal of the marketing contacts module is to provide clients with product information that clients are likely to be interested in. As shown, email addresses and names of the clients are recorded and checked for duplication in the marketing database 114. All leads generated from client input, as shown in FIG. 2, including friend referral email addresses, and names 208, newsletter signups 206, new incorporations 210, repeat clients, and the like 212, are stored in the marketing database 114 wherein potentially new clients, and repeat clients may be obtained or retained through appropriate marketing efforts.

Referring again to FIG. 6, it is shown that client purchase histories 604, affiliate referrals 608, E-newsletter leads and forward click-thru's 618 also generate leads which are stored in the marketing database 114. Marketing database items include but are not limited to: Return type; company name; address; phone; e-mail; contact person; special services request; business code; SIC code; e-mail to accountant; tax tips newsletter; and, client and accountant e-mail.

In addition, the present invention provides for manual entry of client/prospect information in the marketing database 114. According to the present invention, based on whether the user opts-in, or otherwise expresses a preference to be informed of business tax related products and services, the client/prospect information stored in the marketing database 114, including prospect and customer lists, can be made available to an internet marketing company 120, an affiliate database network 125, and the like.

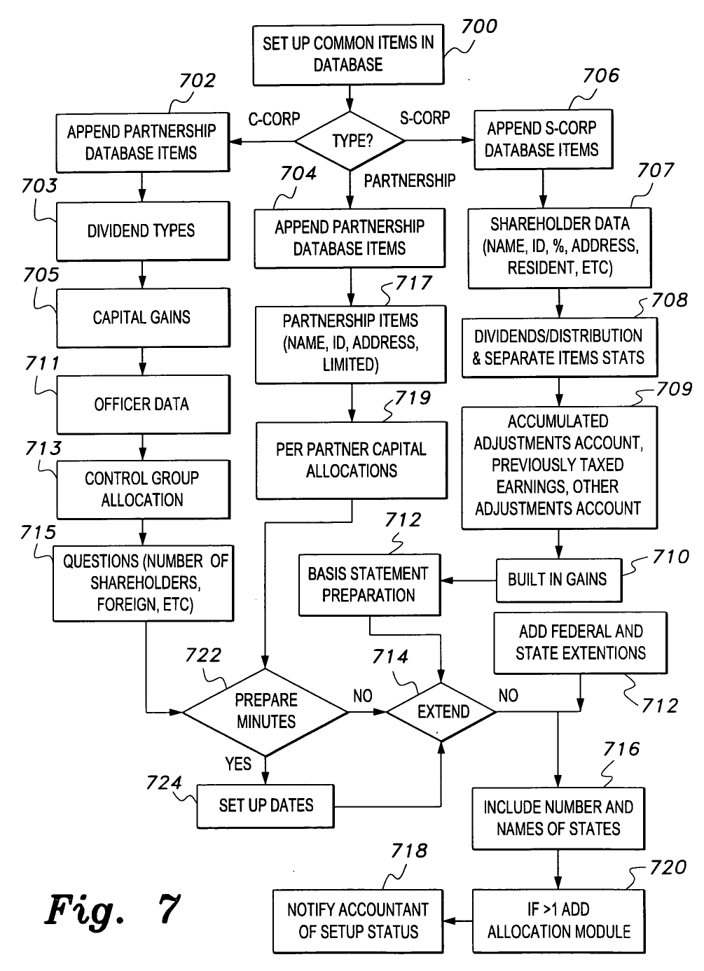

As shown in FIG. 7, common business tax related items 700 are set up in the backend database 112. Once the business entity type has been established, templated database items associated with the established business entity type, such as shown in 702, 704 and 706, are appended to the client's storage area within the backend database 112. For example, a C corporation will generate and append C corporation database items 702 such as dividend types 703, capital gains 705, officer data 711, and control group allocation 713. Specific questions concerning number of shareholders, whether they are foreign, and the like are asked 715.

For Partnerships, partnership database items 704 such as partnership name, ID, address, and whether the partnership is limited 717 are appended. In addition, according to the present invention, per partner capital allocations 719 are ascertained and stored in the backend database. For both partnerships and C corporations, the client input module asks whether to prepare the minutes 722. If the client wishes to have the minutes prepared, set up dates are obtained 724.

In the case of S corporations, data base items are appended 706, such as, e.g., Shareholder name, ID, per-cent ownership, address, and whether the shareholder is a resident, 707 etc. Dividends/distributions and statistics on separate items, such as accumulated adjustments account, previously taxed earnings, and other adjustments account 708, 709 are obtained. Built in gains are applied 710, and a basis statement is prepared 712.

For all types, the Client Input module, CI, asks whether an extension is desired 714 and adds both federal and state extensions 716 if desired by the client. Subsequently, a number of states and names of states are generated and added to the allocation module if greater than 1 718. The tax preparer is then notified of the setup status for the client/prospect 720.

According to the present invention, the Basic Data and Questionnaire, BQ, module drills down to certain specific information required depending on the business entity type being interviewed. The entity formation date is ascertained and stored. Then the entity type is confirmed, preferably by providing a pull down menu from which the user selects from a list of entity types 804. Business code and special status list, (Initial, Final, Names, Addresses, Amended) 806, 808, are determined based on user response to BQ module interview questions. BQ then asks if the IRS can discuss with preparer 810. For S corporations, if the user responds affirmatively, an election date is set 812 and a built in gains amount of cash flow is determined 814 before the user accounting method is ascertained 816. After the accounting method is determined and stored, BQ interviews the user to determine a business activity, a product code and a SIC code 818, which are all recorded in the backend database.

According to the present invention, the user is interviewed about special issues of company ownership. For example, the user is prompted to list all companies, including company name, EIN, and company address, that any shareholder/member owns, and the name of that owner; list the name, address, social security number/EIN and percent ownership of any shareholder who has 50% or more ownership in the company; state whether the company has an interest in or signature or other authority over a financial account in a foreign country and list the name(s) of those countries; list the name, address, SSN or EIN (if any), country of citizenship, and percentage ownership of each class of ownership in the company for any foreign persons or foreign companies having ownership in the company; and, enter the name(s) of the foreign countries from which the company received during the year a distribution, or was the grantor of or transferor to a foreign trust. If other Subchapter S entities exist, the user is prompted for the name, address, EIN, and percent ownership. Subsequently, a control group is determined, a tax shelter is determined, and whether there was an original issue discount debt is determined 820. In addition, according to the present invention, if the business entity is a C corporation then the user is prompted to enter Net Operating Loss and charitable cash flow amounts and years 822.

The Revenue and Capital Gains module, RG, of the present invention prompts the user to enter sales 902, returns and allowances 904. RG inquires whether the business entity sells tangible goods 906. If yes, then expenses and cost of goods sold are determined in the Expenses and Costs of Goods Sold module, ES.

If, as determined from user responses to the RG interview, no sale of non-depreciable assets occurred 908, and no other income is reported 910, 912, then the interview is handed off to the ES module. If non-depreciable assets were sold, then the description, dates, amounts and buy/sell types for all asset sales are determined 914 and stored in the database by RG. RG then determines the cost of goods carry forward losses 916 associated with the asset sales and records whether an S-Revocation trigger exists 918.

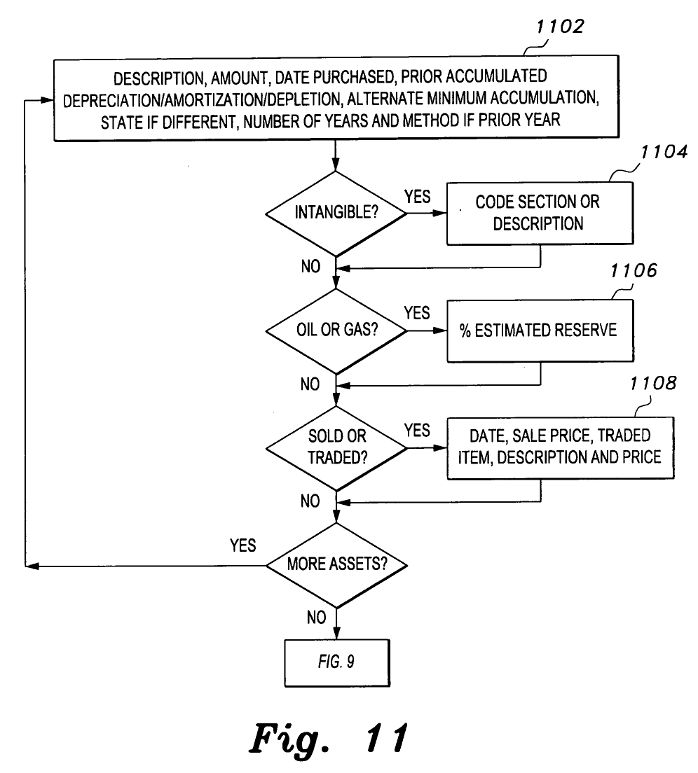

Returning to the Investment Income decision tree of the RG module, if investment income is determined to be present 910, RG interviews the user to determine whether there is interest 920, whether the interest is taxable 922, non-taxable 924, and whether it is leveraged 926. After all the interest is accounted for and properly characterized, RG interviews the user about rentals, prompting the user for a description 930, revenue 932, expenses 934, and for depreciation issues 936. (See FIG. 11 for detailed description of DD module)

Next, according to the present invention, RG interviews the client about dividends 938, whether the dividends are qualified or not, whether the client is a C-corporation, and how the dividends should be characterized according to the 12 types 944, as is known in the accounting art. RG then asks the client about other income, and for a description and amounts of the other income 946, if any, before a final handoff to the ES module.

As previously noted, the present invention provides for an Expenses and Cost of Goods Sold module, ES. The ES module interviews the client about costs and expenses in order to provide the tax preparer with sufficient accounting for tax preparation without further interviewing during the tax preparation stage. Within ES, the user is interviewed about whether the business entity has officer or guaranteed partner compensation and amounts 1000, employee wages and credits 1002, repairs and maintenance 1004, bad debts (for accrual method only) 1006, rent 1008, payroll taxes, property taxes, state and local income tax, licenses, federal income tax, and the like 1010. The client is then interviewed about interest expenses 1012.

When preparing the minutes under the present invention, new loan dates, amounts, shareholders' percentage, and duration are ascertained by ES 1014. In addition, advertising 1016, employee benefits 1018, shareholder or partner amounts 1020, and retirement plan expenses 1022 are ascertained and stored. For the accrual accounting method, a percentage or maximum type of plan amount of qualifying wages 1024 is calculated and stored in the backend database. Subsequently, the client is interviewed about the nature and amount of general expenses not previously covered during the course of the interview 1026.

ES, according to the present invention also determines and stores penalties 1028, if any. If the business entity sells tangible goods, then purchases 1030 and direct labor not taken before 1032, in addition to any other costs 1034 of the tangible goods are stored in the backend database 112. When manufacturing products are used the amount 1036 is ascertained and stored. In addition, a gross profit is calculated from user input of the purchases of goods sold less items withdrawn for personal use; cost of Labor in the Cost of Goods Sold; cost of items built internally then sold or consumed in making goods; other expenses and list amounts included in Cost of Goods Sold; beginning inventory; and, ending inventory.

From interviewing the client, ES determines the inventory method 1038 and whether to apply a write down 1040, and whether the inventory method should use Last In First Out, LIFO 1042. The user is then asked whether there was a change in the accounting method 1044. Subsequently ES hands off the interview process to the Depreciation/Amortization/Depletion module, DD.

Within DD, the present invention provides for interviewing the client about items to be depreciated, amortized or depleted. The user is prompted for a description, amount, date purchased, prior accumulated depreciation, amortization or depletion, alternate minimum accumulation, whether different, number of years and method if prior year 1102. If the asset is intangible then the appropriate code section or description is appended to a record of the asset in the backend database. If the asset is oil or gas, a percentage estimated reserve is ascertained 1106. If the asset is sold or traded, the date, sale price, traded item description and price are recorded in the backend database 1108. According to the present invention, upon completion of the depreciation section of the interview, module DD hands off the interview to a credits/payments/other taxes, CT, module.

The CT module determines whether capital gains are applicable. If they are applicable then stored data gathered during the RG phase of processing is migrated as input to CT 1202. If applicable, fuel tax credit amounts and categories are recorded in the database 1204. R&D expenses are recorded for the current year and prior years 1206. Next, low income, K-1 1208 and any other credits 1210 are applied. Any payment amounts, dates, and whether federal or state 1212 are recorded, then processing is handed off to the Balance Sheet, BT, module.

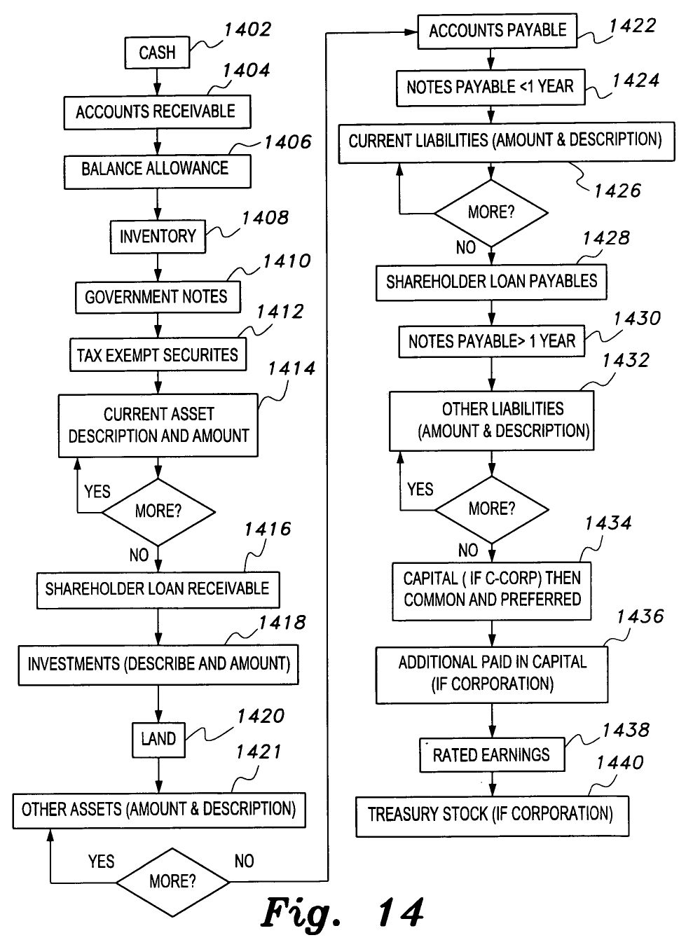

According to the present invention, the Balance Sheet module, BT, provides a means for generating a balance sheet from client interview responses and stored calculations that have been performed during the interview process. As shown in FIG. 14, BT balances cash 1402, accounts receivable 1404, balance allowance 1406, inventory 1408, government notes 1410, and tax-exempt securities 1412. BT interviews the client to obtain a current asset description and amount for each asset 1414. Then shareholder loan and mortgage receivables are included 1416. Investments are included by description and amount 1418.

Land and other assets 1420 are also included for recording a virtual left hand side of a balance sheet in the backend database 112. The user is then interviewed about the amounts and description of any other assets 1421.

Subsequently, a virtual right hand side of the balance sheet is constructed wherein BT interviews the client to ascertain and record accounts payable 1422, notes payable in less than one year 1424, current liabilities amount and description 1426, shareholder loan payables 1428, notes payable in more than 1 year 1430, other liabilities along with their amounts and descriptions 1432. Capital, then common and preferred (stock) 1434, additional paid in capital 1436, retained earnings 1438 and treasury stock 1440 are all included in the virtual right hand side of the balance sheet. If the balance sheet does not balance, the user is prompted to adjust the items until the balance sheet balances.

If during the rebalancing process, shareholder loans increased 1302, then the user is prompted for a date the event occurred for recording into the minutes 1304. If the balance sheet remains balanced, then BT hands off processing to the Basis Calculator, BC 1306.

The Basis Calculator, BC, calculates the basis depending on the user's type of business entity. For a C-corporation, no further basis calculations are required 1502, and processing is handed off to the States module, SS, for interview questions related to state tax calculations. If the business entity is not a C-corporation, then BC interviews the user to determine if the business entity is a shareholder or partnership 1504. The user is prompted for stock and loan payment beginning balances 1506 and current year contributions 1508. Then, processing is handed off to SS.

SS prompts the user for state identification numbers 1602, including tax, secretary estate, and the like. Subsequently, adjustments from federal taxable income, such as, charitable contributions made to in-state charities or in-state governments 1604; amount of state Net Operating Loss carry forward; state credits carry forwards; the name of state credit claimed; and, Water's Edge dividends, i.e., dividends received from out-of-state subsidiaries, are prompted for user input of credits and other non-standard items 1608. The user is then interviewed about the capital structure of the business entity regarding: type of shares, either common or preferred; number of shares authorized; number of shares issued and outstanding; par value per share; and, number of Officers. If the business entity operates in more than one state, SS prompts the user for apportionment factors such as, e.g., sales, payroll and assets 1606. Stored calculations are crosschecked against the prior year's return 1610, according to the present invention.

The minutes preparation module, MS, obtains the data necessary for preparation of the minutes by utilizing previously stored information regarding Officers, Directors, Registered Agents, Shareholders, annual meeting dates; and, new shareholder loans 1702. In addition, MS asks the user about account opening date, bank name and authorized officers if there are any new bank accounts 1704. If there are no new bank accounts, MS prompts the user for dates from K-1 data for new and departing owners, the owners' names and their percentages of ownership 1706. For any other outstanding issues that need to be placed in the minutes, the user is prompted for a description and applicable dates 1708. Control is then passed on to the Certification and Release module, CR.

The CR module ensures that the user certify the interview responses. When the user certifies the following or other similar certification, “I affirm that all the information provided in this interview is accurate, not misleading or misstated, and is complete, to the best of my knowledge. I also acknowledge that I must respond timely to any requests for information to have tax preparation staff complete my return.” 1802, the data stored in the backend database 112 will be sent from the tax organizer website server 110 to the tax preparer 115 for work. When the data is released to the tax preparer 115 in this manner, the user is locked out from making any changes to the data 1804. The tax preparation input file is exported to the accountant 1806, and may have multiple forms of output such as, Excel, ASCII, and the like. The file is also customizable to fit the input specifications of a variety of commercial package tax software vendors. The tax preparer is notified of availability and status is updated 1808. Control is then passed on to the Client Follow-up and Planning module, CP.

Within CP, an accountant, or alternatively accounting software may import a tax preparation input file as prepared by the organizer software 1902. A review process based on the imported file is then initiated 1904. Questions concerning user responses as recorded in the import file may be submitted to the user in a variety of ways, including e-mail. Information is then updated based on user response to the follow-up questions submitted 1906, and subsequently, a tax return is e-filed 1908. Preferably, a copy of the return, minutes, cover letter, and tax tips are e-mailed to the user in a user friendly and compact format such as, for example, a PDF Zip file 1910.

Finally, control is passed on to the Wrap Up module, WU. According to the present invention, the WU module has the capability of copying revised, finalized accounting data to a following year template for display in unchangeable fields for the following tax year 2002. WU may also update a next year database status and unlock 2004. In addition, WU can send a communication, which may, for example, be an e-mail, voicemail, or any other notification means to notify the client and/or client's accountant of next year's setup 2006. WU also can create a file copy of the tax return with IRS transmission confirmations 2008 and then archive this information on, for example, a CD 2010. A database administration record is then set to indicate that the record has been delivered to the client 2012.

It should be noted that according to the present invention, all of the interviewing modules discussed above have the ability to automatically store and return to tax item input mid-stream and with multiple sessions for added flexibility and convenience to the users, i.e., clients. In addition, the crosschecks discussed above are automatically calculated within the program to provide self-verification against the client's own financial statements at the earliest stages of tax data entry and throughout the program.

In addition, the interactive online communication of the present invention provides for swift Q&A response capability for both client and preparer by utilizing, interactive web pages comprising dynamically channeled input screens in a decision-tree format based on prior screen responses given by the user, electronic messaging, e-mail, voice-mail, interactive voice response (IVR) technology, and the like.

The present invention also provides built in database tracking to keep the database segments, i.e., firewalls, between encrypted client data while automatically integrating contact data for both response and marketing purposes. In addition, because of the security capability through the database segmentation according to some unique identifier of the client end user, a stronger relationship building experience for the client is provided.

While it should be understood that implementation of all the modules of the present invention may be done in a variety of software languages, a preferred implementation mode would be to offer open source or generic output for easy mapping and uploading to a variety of commercial-grade and/or professional business tax preparation software packages.

It is to be understood that the present invention is not limited to the embodiment described above, but encompasses any and all embodiments within the scope of the following claims.

I claim:

1. A business tax organizing method performed by a machine executing a program of instructions tangibly embodied in a program storage device readable by the machine, the method comprising the steps of:
providing a web page for an interactive online communication with an at least one user;
identifying a business entity type of the at least one user;
interviewing the at least one user about business tax issues related to the business entity type identified;
storing responses of the at least one user in a backend database;
storing calculations related to the responses of the at least one user in the backend database;
organizing the responses and the calculations into a tax preparation input file; and
transmitting the tax preparation input file to a tax preparer.

2. The business tax organizing method of claim 1, further comprising the step of transmitting the tax preparation input file.

3. The business tax organizing method of claim 1, wherein the step of storing responses further comprises the steps of:
segmenting the backend database to create database segments for each at least one user;
creating mathematical arrays of dynamic tables within the segments; and
encrypting the mathematical arrays of dynamic tables.

4. The business tax organizing method of claim 3, the encrypting step further comprising using a unique identifier of the at least one user as a key for the encrypting wherein a unique, personalized storage area is automatically created for each at least one user.

5. The business tax organizing method of claim 4, wherein the unique identifier of the at least one user comprises an e-mail address of the at least one user.

6. The business tax organizing method of claim 1, further comprising the steps of:
providing the user with a capability to opt-into a marketing database; and
storing a subset of the user responses and related calculations in the marketing database.

7. The business tax organizing method of claim 1, further comprising receiving a certification from the user that affirmatively certifies that the information provided by the user in the interview is accurate, not misleading or misstated, and is complete to the best of the user's knowledge before said transmitting step.

8. The business tax organizing method of claim 1, further comprising the steps of:
providing a virtual left hand side of a balance sheet responsive to user inputs of asset tax data;
providing a virtual right hand side of a balance sheet responsive to user inputs of liability tax data; and
prompting the user to adjust the asset and liability tax data until the balance sheet balances.

9. A business tax organizing system comprising:
means for interactively communicating with a user of the business tax organizing system;
means for identifying a business entity type of the user; means for interviewing the user about business tax issues related to the business entity type identified;
means for storing responses of the user;
means for storing calculations related to the responses of the user;
means for organizing the responses and the calculations; and
means for transmitting the organized responses and calculations to a tax preparer.

10. The business tax organizing system of claim 9, further comprising means for transmitting the organized responses and related calculations to a tax preparation computer program.

11. The business tax organizing system of claim 9, wherein the means for storing further comprises:
means for segmenting the storage for each user;
means for dynamically allocating storage space according to each user's requirements; and
means for securing each user's stored data.

12. The business tax organizing system of claim 9, further comprising means for retaining repeat clients.

13. The business tax organizing system of claim 9, further comprising means for obtaining new clients.

14. The business tax organizing system of claim 9, further comprising means for providing a subset of the responses of the user and related calculations to an Internet marketing company.

15. The business tax organizing system of claim 9, further comprising means for preparing corporate and LLC minutes based on the responses of the user.

16. The business tax organizing system of claim 9, further comprising means for simultaneously communicating with multiple client sources, independent marketing databases, and multiple accounting firms having multiple tax packages.

17. The business tax organizing system of claim 9, further comprising means for dynamically channeling input screens to interactive web pages based on prior screen responses given by the user.
